(19) United States
(12) Patent Application Publication
(10) Pub. No.: US 2014/0117793 A1
(43) Pub. Date: May 1, 2014

(54) TRANSVERSE FLUX MOTOR

(71) Applicant: KABUSHIKI KAISHA TOSHIBA, Tokyo (JP)

(72) Inventor: Hiroshi TAKAHASHI, Kanagawa-ken (JP)

(73) Assignee: KABUSHIKI KAISHA TOSHIBA, Tokyo (JP)

(21) Appl. No.: 14/013,738

(22) Filed: Aug. 29, 2013

(30) Foreign Application Priority Data
Sep. 18, 2012 (JP) 2012-205057

(51) Int. Cl. H02K 1/12; H02K 9/00

(52) U.S. Cl. CPC H02K 1/12; H02K 9/00
USPC 310/52; 310/180

(57) ABSTRACT

A transverse flux motor of an aspect of embodiments includes a rotor having an outer peripheral surface, an annular armature coil wound around a rotational axis of the rotor, a stator core including a pair of magnetic pole portions along an axial direction of the rotational axis, each magnetic pole portion facing the outer peripheral surface of the rotor across a gap and a supporting member containing the armature coil, and having a plurality of protruding portions protruding in the axial direction and provided around the rotational axis, wherein the adjacent two protruding portions around the rotational axis support at least part of the magnetic pole portions between the adjacent two protruding portions.

### CROSS-REFERENCE TO RELATED APPLICATION

This application is based upon and claims the benefit of priority of the prior Japanese Patent Application No. 2012-205057, filed on Sep. 18, 2012, the entire contents of which are incorporated herein by reference.

### FIELD

The embodiments discussed herein are related to a transverse flux motor.

### BACKGROUND

In a transverse flux motor (hereinafter called merely a motor), a stator includes a toroidal coil wound coaxially with a rotor, and multiple U-shaped stator cores disposed around the toroidal coil at circumferentially spaced intervals. The stator cores each have magnetic pole portions at the two ends of the U-shape. The rotor includes magnetic pole portions disposed along a circumferential direction (generally, a set of permanent magnets of different polarities alternating with each other, or a set of permanent magnets and rotor cores). The magnetic pole portions of the rotor are oriented facing the magnetic pole portions of the stator cores. Generally, the stator and the rotor are covered with a casing, and the stator cores are fixedly cantilevered on an inner peripheral surface of the casing with joining portions in between.

In such a motor, as the motor runs, a magnetic force which intermittently changes its direction is produced in the circumferential direction on the magnetic pole portions, in particular, of the stator cores, facing the rotor. Therefore, the stator cores fixedly cantilevered on the casing may undergo vibrations centered at the portions of joining to the casing. Such vibrations cause noise generation as well as deterioration in strength of the motor.

Incidentally, literature related to the above-mentioned technology is given below, and the entire contents thereof are incorporated herein by reference.
Patent Literature 1: Japanese Patent No. 4085059

### BRIEF DESCRIPTION OF THE DRAWINGS

FIGS. 1A-1D are views illustrating a base unit of a motor according to a first embodiment, especially, FIG. 1A is a perspective view, FIG. 1B is a sectional view, FIG. 1C is a perspective view illustrating structural elements in separate form and FIG. 1D is a sectional view of a supporting member of the base unit;

FIGS. 2A-2B are top and bottom views respectively illustrating the supporting member of the base unit of the motor according to the first embodiment and FIG. 2c is a view illustrating a stator core;

FIGS. 3A-3B are views illustrating a base unit of a motor according to a second embodiment, especially, FIG. 3A is a perspective view and FIG. 3B is a sectional view;

FIGS. 4A-4B are views illustrating a base unit of a motor according to a third embodiment, especially, FIG. 4A is a perspective view and FIG. 4B is a sectional view;

FIGS. 5A-5B are views illustrating a base unit of a motor according to a fourth embodiment, especially, FIG. 5A is a perspective view and FIG. 5B is a sectional view;

FIGS. 6A-6B are views illustrating a base unit of a motor according to a fifth embodiment, especially, FIG. 6A is a perspective view and FIG. 6B is a sectional view;

FIGS. 7A-7B are views illustrating a base unit of a motor according to a sixth embodiment, especially, FIG. 7A is a perspective view and FIG. 7B is a sectional view;

FIGS. 8A-8B are views illustrating a base unit of a motor according to a seventh embodiment, especially, FIG. 8A is a perspective view and FIG. 8B is a sectional view;

FIGS. 9A-9C are views illustrating a base unit of a motor according to an eighth embodiment, especially, FIG. 9A is a perspective view, FIG. 9B is a sectional view and FIG. 9C is a sectional view of a supporting member of the base unit;

FIGS. 10A-10B are top and bottom views respectively illustrating the supporting member of the base unit of the motor according to the eighth embodiment and FIG. 10c is a view for explaining the supporting member;

FIGS. 11A-11B are views illustrating a motor according to a ninth embodiment, especially, FIG. 11A is a perspective view and FIG. 11B is a sectional view;

FIGS. 12A-12B are views illustrating a motor according to a tenth embodiment, especially, FIG. 12A is a perspective view and FIG. 12B is a sectional view;

FIGS. 13A-13B are views illustrating a motor according to an eleventh embodiment, especially, FIG. 13A is a perspective view and FIG. 13B is a sectional view; and

FIGS. 14A-14B are views illustrating a motor according to a twelfth embodiment, especially, FIG. 14A is a perspective view and FIG. 14B is a sectional view.

### DETAILED DESCRIPTION

In view of the above circumstances, a transverse flux motor comprising a rotor having an outer peripheral surface, an annular armature coil wound around a rotational axis of the rotor, a stator core including a pair of magnetic pole portions along an axial direction of the rotational axis, each magnetic pole portion facing the outer peripheral surface of the rotor across a gap and a supporting member containing the armature coil, and having a plurality of protruding portions protruding in the axial direction and provided around the rotational axis, wherein the adjacent two protruding portions around the rotational axis support at least part of the magnetic pole portions between the adjacent two protruding portions.

According to an aspect of embodiments, a transverse flux motor capable of suppressing noise generation can be provided.

Embodiments will be described below.

### First Embodiment

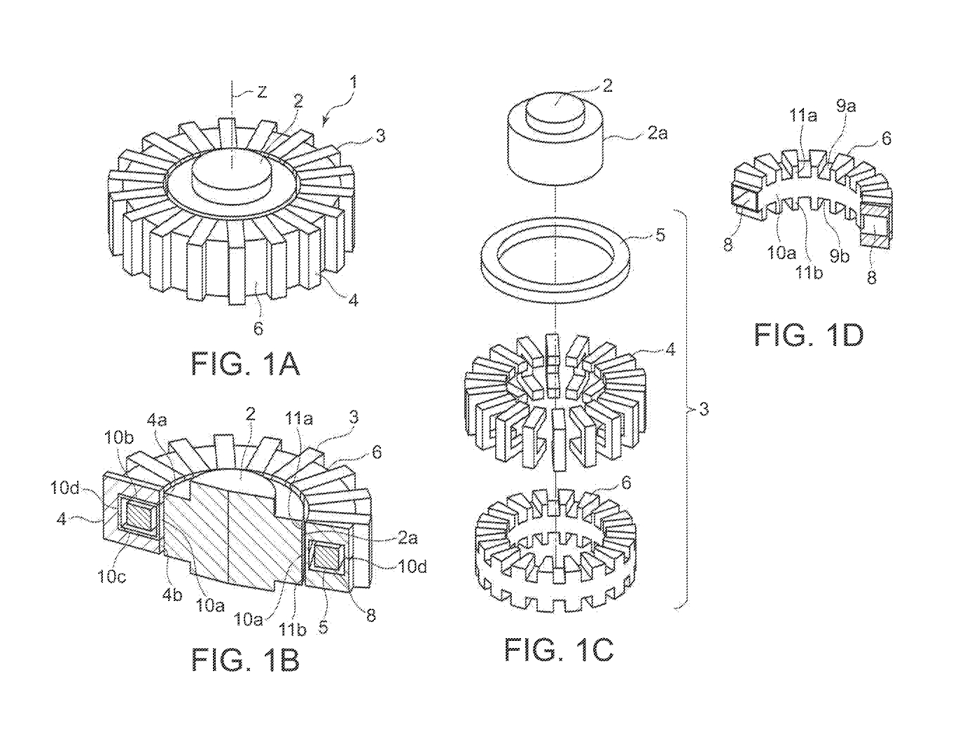

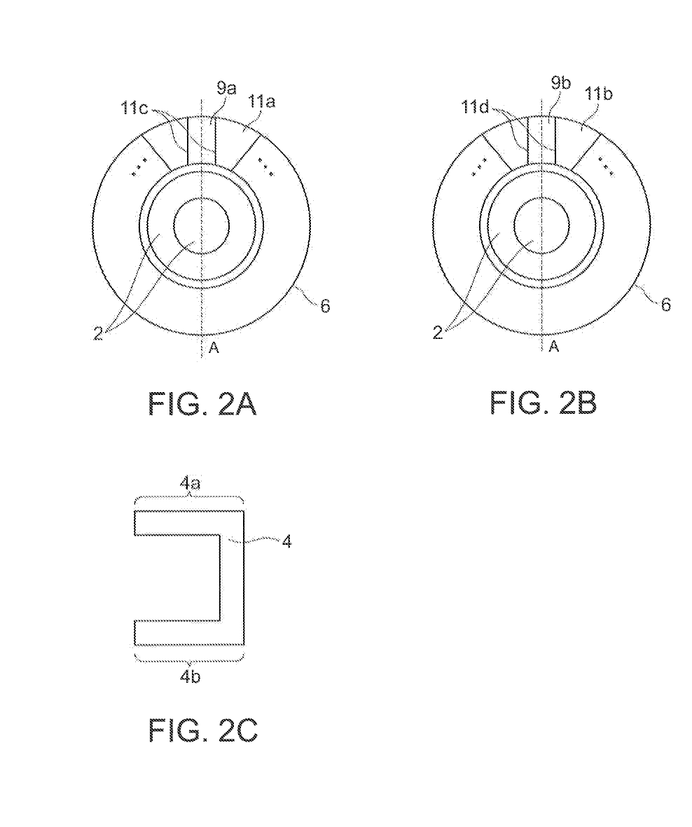

Description will be given below with reference to FIGS. 1A-1D and 2A-2B with regard to a base unit 1 of a motor according to a first embodiment. FIG. 1A is a perspective view illustrating the base unit 1 of the motor according to the first embodiment; FIG. 1B is a vertical longitudinal sectional view of the base unit 1; FIG. 1C is a perspective view illustrating, in separate form, structural elements of the base unit 1; and FIG. 1D is a vertical longitudinal sectional view of a supporting member 6 of the base unit 1. Also, FIG. 2A is a top view of the supporting member 6, and FIG. 2B is a bottom view of the supporting member 6.

The base unit 1 includes a rotor 2 supported rotatably by a bearing (unillustrated) along a rotational axis z, and an armature 3 disposed around the rotational axis z in such a way as to surround the rotor 2 as a whole.

The rotor 2 is a cylindrical member which forms a rotor outer peripheral surface 2a, centering around the rotational axis z. The rotor outer peripheral surface 2a is provided with different magnetic poles alternating with each other, formed in a circumferential direction. In this case, for example, the rotor 2 may include rotor cores and permanent magnets alternating with each other, disposed along the circumferential direction, or may include permanent magnets alone or rotor cores alone.

The armature 3 includes eighteen stator cores 4 disposed facing the rotor outer peripheral surface 2a of the rotor 2 across a predetermined air gap, an annular armature coil 5 formed concentrically with the rotor 2, centering around the rotational axis z, and the supporting member 6 containing the armature coil 5 and supporting the eighteen stator cores 4 disposed at equally spaced intervals around the rotational axis z.

Each stator core 4 includes a first magnetic pole portion 4a disposed facing the rotor outer peripheral surface 2a across a predetermined air gap, and a second magnetic pole portion 4b provided clear of the first magnetic pole portion 4a along the rotational axis z and disposed facing the rotor outer peripheral surface 2a across a predetermined air gap, and is formed in the general shape of a letter U. In this case, the first magnetic pole portion 4a and the second magnetic pole portion 4b have different magnetic poles. Each stator core 4 orients the first magnetic pole portion 4a and the second magnetic pole portion 4b with the portions 4a, 4b facing the magnetic poles formed on the rotor outer peripheral surface 2a. Incidentally, the first magnetic pole portion 4a and the second magnetic pole portion 4b as employed herein are defined as arm portions of the U-shape of the stator core 4 (refer to FIG. 2C).

The armature coil 5 is disposed around the periphery of the rotor 2 concentrically with the rotor 2, centering around the rotational axis z. A current generator (unillustrated) is connected to the armature coil 5 to feed an alternating current generated by the current generator through the armature coil 5 when the motor runs. A conductor (for example, copper) is available for use as a structural component for the armature coil 5.

The supporting member 6 is an annular member covering the rotor 2 around the rotational axis z. The supporting member 6 is integrally formed with a first member 10a which forms an inner peripheral surface of the supporting member 6, a second member 10b which forms an upper surface of the supporting member 6, a third member 10c which forms a lower surface of the supporting member 6, and a fourth member 10d which forms an outer peripheral surface of the supporting member 6. Also, the supporting member 6 is provided with a cooling channel 8 surrounded by the first to fourth members 10a to 10d and formed concentrically with the rotor 2, centering around the rotational axis z. The armature coil 5 is supported in the cooling channel 8 in about its central portion in cross section by a supporting member (unillustrated). A cooling medium (unillustrated) flows through the cooling channel 8.

An upper surface of the second member 10b is provided with multiple protruding portions 11a formed along a circumferential direction of the annular shape. Each of the protruding portions 11a has, as a side surface, a mounting surface 11c parallel to a reference plane A extending along a radial direction of the annular shape. Also, a lower surface of the third member 10c is provided with protruding portions 11b formed along the circumferential direction of the annular shape and in phase with the protruding portions 11a. Each of the protruding portions 11b has, as a side surface, a mounting surface 11d parallel to the reference plane A extending along the radial direction of the annular shape. Each stator core 4 is provided in such a way as to engage with a recessed portion 9a formed between the mounting surfaces 11c of the adjacent protruding portions 11a, and a recessed portion 9b formed between the mounting surfaces 11d of the adjacent protruding portions 11b. In other words, each stator core 4 is supported as a whole by the supporting member 6 by bringing a side surface of the first magnetic pole portion 4a into fixed contact with the mounting surface 11c, and bringing a side surface of the second magnetic pole portion 4b into fixed contact with the mounting surface 11d.

According to the motor of the first embodiment, the supporting member 6 supports the stator cores 4, and thereby, the first magnetic pole portions 4a and the second magnetic pole portions 4b of the stator cores 4 are fixed in contact with the mounting surfaces, and thus, vibration of the stator cores 4 can be suppressed when the motor runs. This enables suppressing noise generation incident to the vibration.

Also, the supporting member 6 supports the stator cores 4 integrally, and thus, there is a small amount of variations in the positions of the stator cores 4 in a direction of rotation, so that characteristic variations of electromagnetic force generation due to the variations in the positions in the direction of rotation can be reduced to small amounts. As a result, vibration of mechanical detrimental high-order components other than rotational components can be eliminated from the electromagnetic force acting between the rotor and the stator, which in turn enables achieving more stable rotational operation and also suppressing noise generation incident to the vibration of the high-order components.

According to the motor of the first embodiment, further, the armature coil 5 is disposed in the cooling channel 8, and thus, in the event of heat generation caused by a copper loss of the armature coil 5 incident to the turn-on of current, the armature coil 5 is directly cooled by the cooling medium in the cooling channel 8, so that the heat is effectively removed from the armature coil 5. Also, in the event of heat generation caused by an iron loss which occurs in the rotor 2, the rotor 2 is indirectly cooled by the first member 10a which forms part of the supporting member 6 disposed facing the rotor outer peripheral surface 2a across a predetermined air gap. Heat is drained from the first member 10a by the cooling medium in the cooling channel 8, so that the heat is effectively removed from the first member 10a. Also, in the event of heat generation caused by an iron loss which occurs in the stator cores 4, the heat is drained from the stator cores 4 by the cooling medium in the cooling channel 8 by heat conduction through contact surfaces of the protruding portions 11a, 11b which form part of the supporting member 6 supporting the stator cores 4 and contacting the stator cores 4, and through bottom surfaces of the recessed portions 9a, 9b, so that the heat is effectively removed from the stator cores 4. In addition, the protruding portions 11a, 11b which form part of the supporting member 6 are disposed facing the rotor outer peripheral surface 2a across a predetermined air gap, and thus, the heat produced due to the iron loss which occurs in the rotor 2 is more effectively drained by the cooling medium in the cooling channel 8, so that the heat is removed from the rotor 2.

As described above, the armature coil 5 is directly cooled in the cooling channel 8, the rotor 2 is indirectly cooled by the first member 10a and the protruding portions 11a, 11b which form part of the supporting member 6, and the stator cores 4 are indirectly cooled by the heat conduction through the contact surfaces of the protruding portions 11a, 11b which form part of the supporting member 6 (or through the bottom surfaces of the recessed portions 9a, 9b). Thus, the supporting member 6 acts to provide effective cooling for both the rotor 2 and the armature 3 and hence may be expected to achieve an extremely high level of cooling performance.

Further, the supporting member 6 is integrally configurable as a whole to thus achieve a simplification of a cooling structure and, in turn, enable contribution to size reduction of the motor. Also, it is not necessary to provide a separate member for supporting the stator cores 4, which in turn can contribute to further reduction in the size of the motor.

Incidentally, the supporting member 6 is made of a non-magnetic and thermally conductive material and, in addition, is constructed of an electrically insulating material. Desirably, the cooling medium is an electrical insulating fluid or gas such as insulating oil. Also, although the number of stator cores 4 is described as being eighteen, the number of stator cores 4 is not so limited but may be appropriately changed to the optimum number for requirements for motor design. The same goes for the following description.

### Second Embodiment

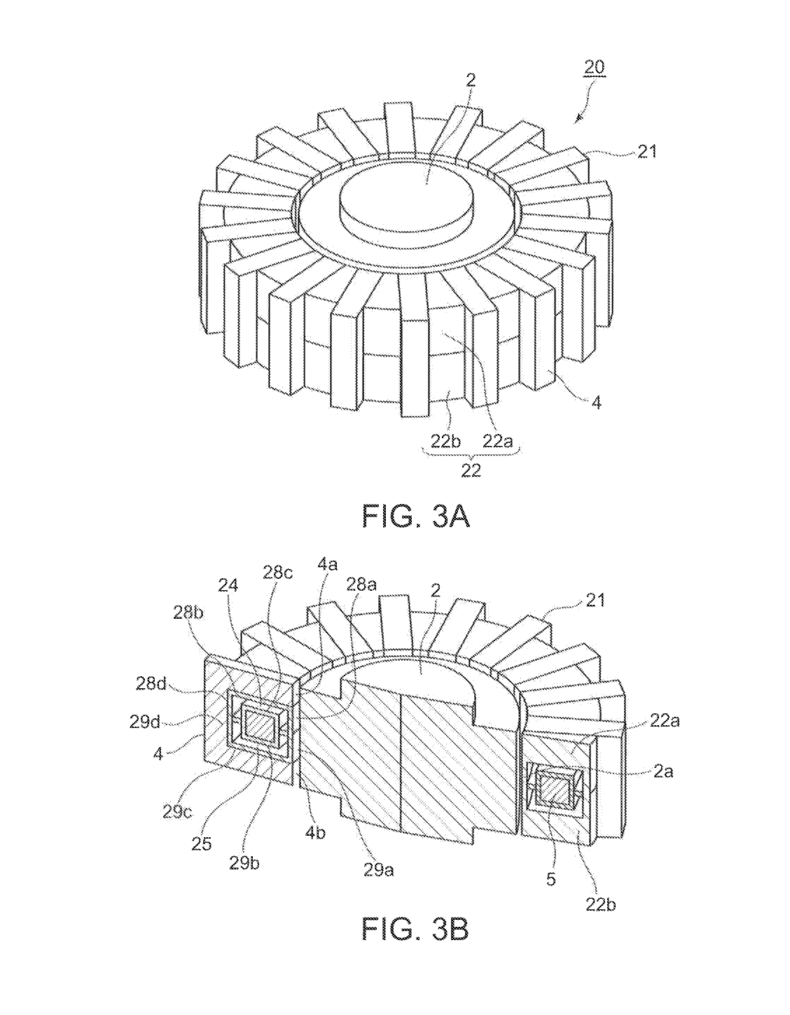

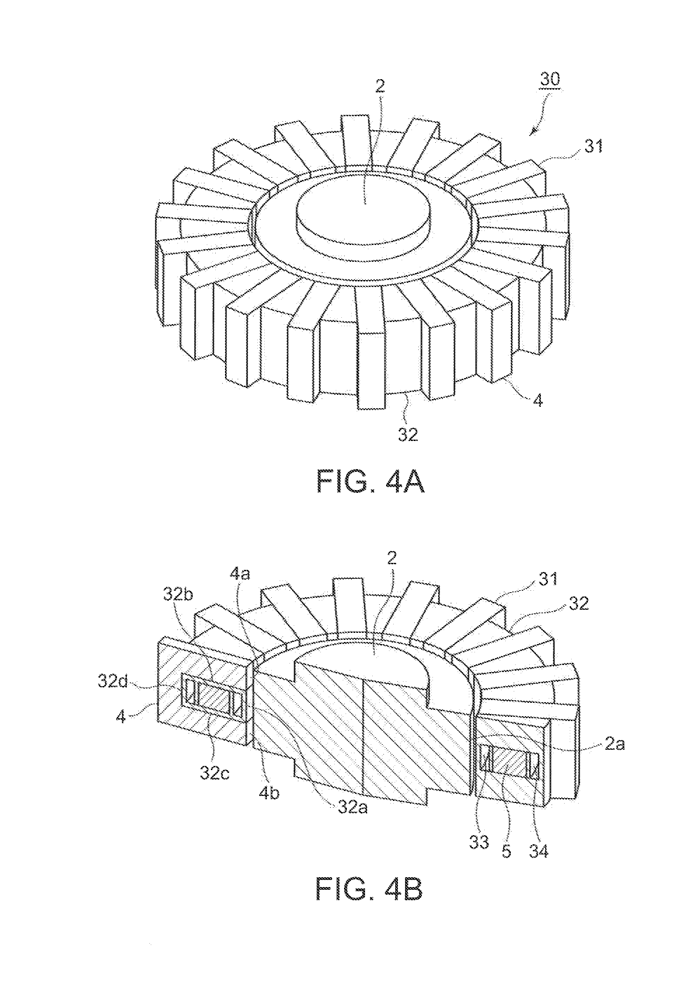

FIGS. 3A-3B illustrate a base unit 20 of a motor according to a second embodiment. FIG. 3A is a perspective view illustrating the base unit 20, and FIG. 3B is a vertical longitudinal sectional view of the base unit 20. Since the base unit 20 is based on the base unit 1 illustrated in FIG. 1A, description of details previously described will be omitted, and different portions alone will be described. The same goes for FIGS. 4A-4B and the following drawings.

The base unit 20 includes the rotor 2 and an armature 21. Further, the armature 21 includes the eighteen stator cores 4, the armature coil 5, and a supporting member 22 containing the armature coil 5 and supporting the eighteen stator cores 4 disposed at equally spaced intervals around the rotational axis z. The supporting member 22 is an annular member covering the rotor 2 around the rotational axis z, and includes a first supporting member 22a and a second supporting member 22b as two portions into which the supporting member 22 is divided in such a way as to sandwich the armature coil 5 therebetween in a direction of the rotational axis z.

The first supporting member 22a is integrally formed with a first member 28a which forms an inner peripheral surface of the supporting member 22, a second member 28b which forms an upper surface of the supporting member 22, a third member 28c which forms a lower surface of the first supporting member 22a and is a mounting surface for the armature coil 5, and a fourth member 28d which forms an outer peripheral surface of the supporting member 22. Also, the first supporting member 22a is provided with a cooling channel 24 surrounded by the first to fourth members 28a to 28d and formed concentrically with the rotor 2, centering around the rotational axis z. A cooling medium (unillustrated) flows through the cooling channel 24.

The second supporting member 22b is integrally formed with a fifth member 29a which forms the inner peripheral surface of the supporting member 22, a sixth member 29b which forms an upper surface of the second supporting member 22b of the supporting member 22 and is the mounting surface for the armature coil 5, a seventh member 29c which forms a lower surface of the supporting member 22, and an eighth member 29d which forms the outer peripheral surface of the supporting member 22. Also, the second supporting member 22b is provided with a cooling channel 25 surrounded by the fifth to eighth members 29a to 29d and formed concentrically with the rotor 2, centering around the rotational axis z. A cooling medium (unillustrated) flows through the cooling channel 25.

The armature coil 5 is supported by the supporting member 22 by being sandwiched in between the third member 28c of the first supporting member 22a and the sixth member 29b of the second supporting member 22b. Incidentally, since a configuration of the supporting member 22 for supporting the stator cores 4 is the same as that of the first embodiment, description of the configuration will be omitted.

According to the motor of the second embodiment, the armature coil 5 is disposed externally of the cooling channels 24, 25, and thus, it is not necessary that the armature coil 5 be designed specifically to operate in the cooling medium with stability for long periods, which in turn can contribute to enhancement of ease of fabrication of the armature coil 5 and achievement of cost reduction. Also, in the event of heat generation caused by a copper loss of the armature coil 5 incident to the turn-on of current, the armature coil 5 is indirectly cooled by the third member 28c and the sixth member 29b which form part of the supporting member 22 configured in such a way as to surround the armature coil 5 as a whole. Also, in the event of heat generation caused by an iron loss which occurs in the rotor 2, the rotor 2 is indirectly cooled by the first member 28a and the fifth member 29a which form part of the supporting member 22 disposed facing the rotor outer peripheral surface 2a across a predetermined air gap. Heat is drained from the first member 28a and the fifth member 29a by the cooling medium in the cooling channels 24, 25, so that the heat is effectively removed from the first member 28a and the fifth member 29a. Further, in the event of heat generation caused by an iron loss which occurs in the stator cores 4, the heat is removed from the stator cores 4 by the same action as that of the base unit 1. Thus, the supporting member 22 acts to provide effective cooling for both the rotor 2 and the armature 21 and hence may be expected to achieve an extremely high level of cooling performance.

Incidentally, the supporting member 22 is constructed of a non-magnetic and thermally conductive material and, in addition, is desirably constructed of an electrically insulating material when electrical resistance across the first supporting member 22a and the second supporting member 22b is low. Also, the cooling medium is not limited to an electrical insulating fluid or gas such as insulating oil, and water or other cooling media may be widely used; however, the cooling medium is selected according to requirements for actual design.

Generally, when the motor runs at high torque and low speed of revolution, a large current is passed through the armature coil, and thus, the armature coil reaches a high temperature. Meanwhile, when the motor runs at high speed of revolution, the rotor, the permanent magnets, the bearing, lubricating oil or the like reaches a high temperature due to the influence of friction incident to the revolution or a significant increase in iron losses which takes place in the rotor cores and the permanent magnets. Therefore, anything may be used as a material for the supporting member 22, provided that the material has thermal conductivity capable of compensating for heat resistance of a part which reaches the highest temperature during motor drive, within a predetermined range of motor drive conditions, or capable of suppressing performance degradation due to heat within tolerances of design conditions or the like. Aluminum, stainless steel, duralumin, aluminum oxide, and alloys containing these may be used by way of example.

### Third Embodiment

FIGS. 4A-4B illustrates a base unit 30 of a motor according to a third embodiment. FIG. 4A is a perspective view illustrating the base unit 30, and FIG. 4B is a vertical longitudinal sectional view of the base unit 30.

The base unit 30 includes the rotor 2 and an armature 31. Further, the armature 31 includes the eighteen stator cores 4, the armature coil 5, and a supporting member 32 containing the armature coil 5 and supporting the eighteen stator cores 4 disposed at equally spaced intervals around the rotational axis.

The supporting member 32 is an annular member covering the rotor 2 around the rotational axis z. The supporting member 32 is integrally formed with a first member 32a which forms an inner peripheral surface of the supporting member 32, a second member 32b which forms an upper surface of the supporting member 32, a third member 32c which forms a lower surface of the supporting member 32, and a fourth member 32d which forms an outer peripheral surface of the supporting member 32. The first member 32a is provided with a cooling channel 33 formed concentrically with the rotor 2, centering around the rotational axis z. Also, the fourth member 32d is provided with a cooling channel 34 formed concentrically with the rotor 2, centering around the rotational axis z. A cooling medium (unillustrated) flows through the cooling channels 33 and 34.

The armature coil 5 is supported by the supporting member 32 by being fixed in contact with the first member 32a, the second member 32b, the third member 32c, and the fourth member 32d. Incidentally, since a configuration of the supporting member 32 for supporting the stator cores 4 is the same as that of the first embodiment, description of the configuration will be omitted.

According to the motor of the third embodiment, the cooling channels 33, 34 are formed separately in an outer peripheral portion and an inner peripheral portion of the armature coil 5, and thus, the width of the base unit 30 in the direction of the rotational axis z can be reduced, which in turn can contribute to size reduction of the overall motor structure. Also, in the event of heat generation caused by a copper loss of the armature coil 5, the armature coil 5 is indirectly cooled by the first member 32a to the fourth member 32d which form part of the supporting member 32 configured in such a way as to surround the armature coil 5 as a whole. Also, in the event of heat generation caused by an iron loss of the rotor 2, the rotor 2 is indirectly cooled by the first member 32a which forms part of the supporting member 32 disposed facing the rotor outer peripheral surface 2a. Further, in the event of heat generation caused by an iron loss of the stator cores 4, the heat is removed from the stator cores 4 by the same action as that of the base unit 1.

Incidentally, the supporting member 32 is made of a non-magnetic and thermally conductive material and, in addition, is constructed of an electrically insulating material. Also, the cooling medium is not limited to an electrical insulating fluid or gas such as insulating oil, and water or other cooling media may be widely used.

### Fourth Embodiment

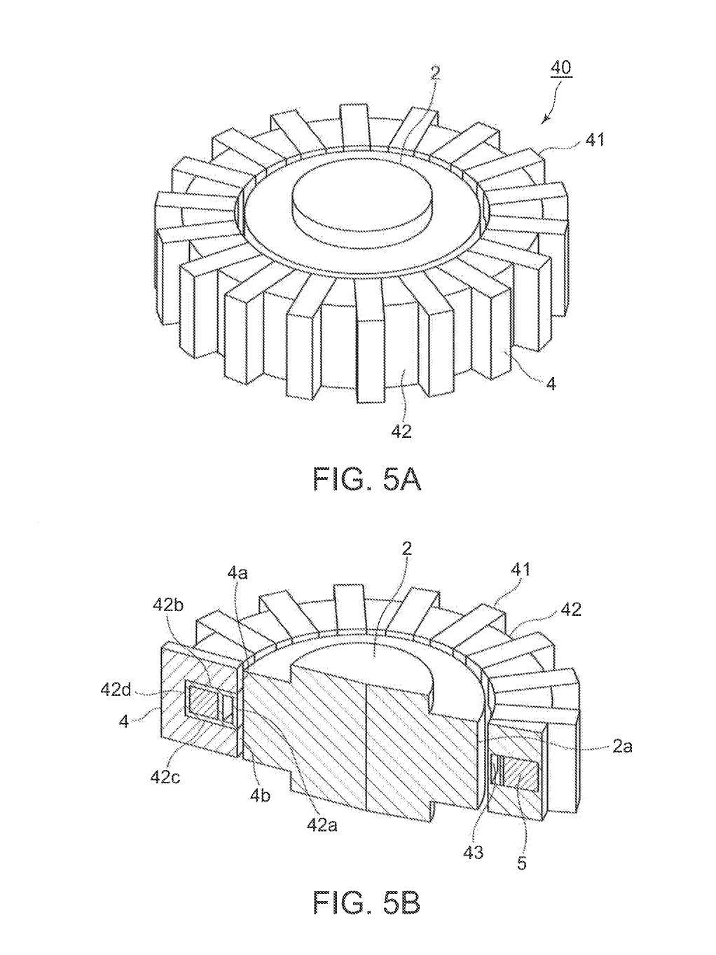

FIGS. 5A-5B illustrate a base unit 40 of a motor according to a fourth embodiment. FIG. 5A is a perspective view illustrating the base unit 40, and FIG. 5B is a vertical longitudinal sectional view of the base unit 40.

The base unit 40 includes the rotor 2 and an armature 41. Further, the armature 41 includes the eighteen stator cores 4, the armature coil 5, and a supporting member 42 containing the armature coil 5 and supporting the eighteen stator cores 4 disposed at, equally spaced intervals around the rotational axis.

The supporting member 42 is an annular member covering the rotor 2 around the rotational axis z. The supporting member 42 is integrally formed with a first member 42a which forms an inner peripheral surface of the supporting member 42, a second member 42b which forms an upper surface of the supporting member 42, a third member 42c which forms a lower surface of the supporting member 42, and a fourth member 42d which forms an outer peripheral surface of the supporting member 42. The first member 42a is provided with a cooling channel 43 formed concentrically with the rotor 2, centering around the rotational axis z. A cooling medium (unillustrated) flows through the cooling channel 43.

The armature coil 5 is supported by the supporting member 42 by being fixed in contact with the first member 42a, the second member 42b, the third member 42c, and the fourth member 42d. Incidentally, since a configuration of the supporting member 42 for supporting the stator cores 4 is the same as that of the first embodiment, description of the configuration will be omitted.

According to the motor of the fourth embodiment, the cooling channel 43 is formed in the inner peripheral portion of the armature coil 5, and thus, the width of the base unit 40 in the direction of the rotational axis z can be reduced and, moreover, the small-sized motor structure having a reduced dimension in the radial direction can be provided. Also, in the event of heat generation caused by a copper loss of the armature coil 5, the armature coil 5 is indirectly cooled by the first member 42a to the fourth member 42d which form part of the supporting member 42 configured in such a way as to surround the armature coil 5 as a whole. Also, in the event of heat generation caused by iron losses of the rotor 2 and the stator cores 4, the heat is removed from the rotor 2 and the stator cores 4 by the same action as that of the base unit 1.

Incidentally, the supporting member 42 is made of a non-magnetic and thermally conductive material and, in addition, is constructed of an electrically insulating material. Also, the cooling medium is not limited to an electrical insulating fluid or gas such as insulating oil, and water or other cooling media may be widely used.

### Fifth Embodiment

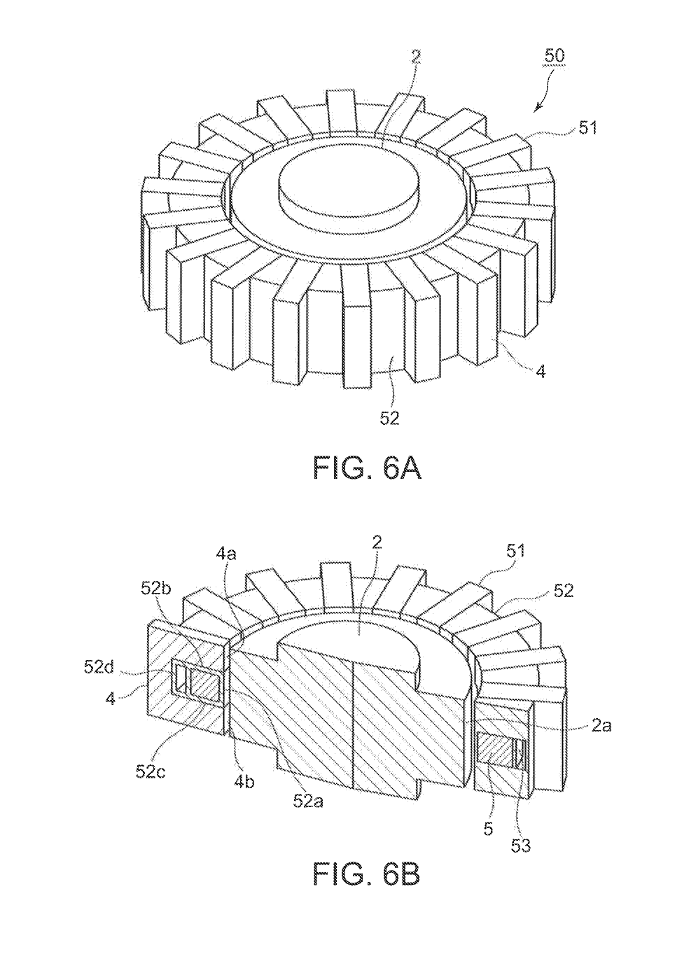

FIGS. 6A-6B illustrate a base unit 50 of a motor according to a fifth embodiment. FIG. 6A is a perspective view illustrating the base unit 50, and FIG. 6B is a vertical longitudinal sectional view of the base unit 50.

The base unit 50 includes the rotor 2 and an armature 51. Further, the armature 51 includes the eighteen stator cores 4, the armature coil 5, and a supporting member 52 containing the armature coil 5 and supporting the eighteen stator cores 4 disposed at equally spaced intervals around the rotational axis.

The supporting member 52 is an annular member covering the rotor 2 around the rotational axis z. The supporting member 52 is integrally formed with a first member 52a which forms an inner peripheral surface of the supporting member 52, a second member 52b which forms an upper surface of the supporting member 52, a third member 52c which forms a lower surface of the supporting member 52, and a fourth member 52d which forms an outer peripheral surface of the supporting member 52. The fourth member 52d is provided with a cooling channel 53 formed concentrically with the rotor 2, centering around the rotational axis z. A cooling medium (unillustrated) flows through the cooling channel 53.

The armature coil 5 is supported by the supporting member 52 by being fixed in contact with the first member 52a, the second member 52b, the third member 52c, and the fourth member 52d. Incidentally, since a configuration of the supporting member 52 for supporting the stator cores 4 is the same as that of the first embodiment, description of the configuration will be omitted.

According to the motor of the fifth embodiment, the cooling channel 53 is formed in the outer peripheral portion of the armature coil 5, and thus, the small-sized motor structure can be provided in which the base unit 50 has reduced dimensions in the direction of the rotational axis and in the radial direction. Incidentally, the base unit 50 has the advantage that a flow path (unillustrated) to be linked to the cooling channel 53 can be formed in simpler structure, although a cooling effect may become lessened by a difference in heat conduction path length between a heat-producing portion and the cooling channel, as compared to the base unit 40 in which the cooling channel 43 is formed in the inner peripheral portion of the armature coil 5.

Incidentally, the supporting member 52 is made of a non-magnetic and thermally conductive material and, in addition, is constructed of an electrically insulating material. Also, the cooling medium is not limited to an electrical insulating fluid or gas such as insulating oil, and water or other cooling media may be widely used.

### Sixth Embodiment

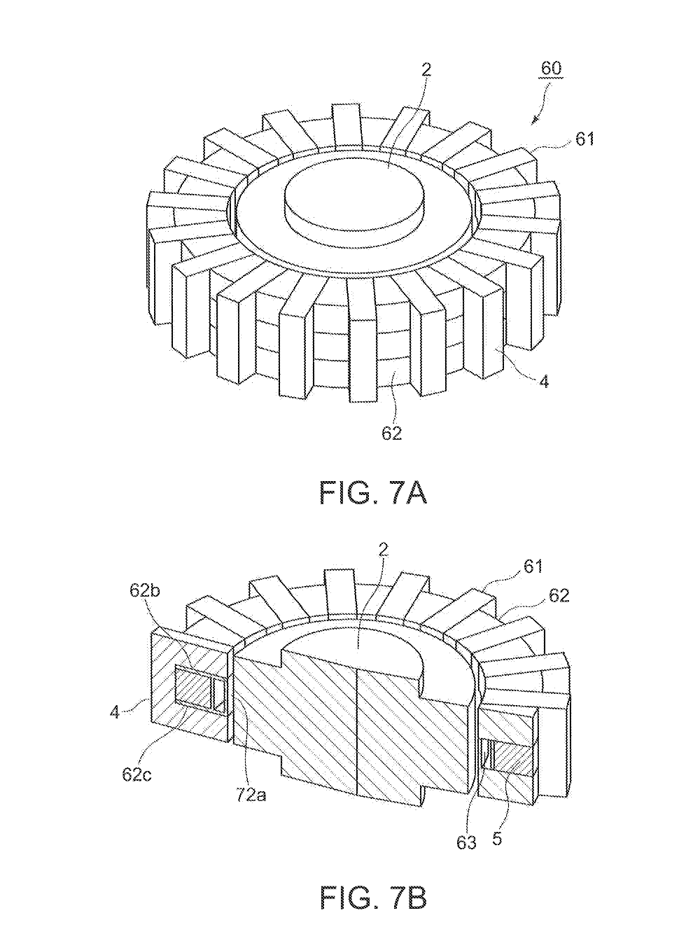

FIGS. 7A-7B illustrate illustrates a base unit 60 of a motor according to a sixth embodiment. FIG. 7A is a perspective view illustrating the base unit 60, and FIG. 7B is a vertical longitudinal sectional view of the base unit 60.

The base unit 60 includes the rotor 2 and an armature 61. Further, the armature 61 includes the eighteen stator cores 4, the armature coil 5, and a supporting member 62 containing the armature coil 5 and supporting the eighteen stator cores 4 disposed at equally spaced intervals around the rotational axis. The base unit 60 is different in that the supporting member 62 surrounds the armature coil 5 as a whole exclusive of an outer peripheral surface of the armature coil 5, as compared to the base unit 40 of FIG. 5A.

The supporting member 62 is integrally formed with a first member 62a which forms an inner peripheral surface of the supporting member 62, a second member 62b which forms an upper surface of the supporting member 62, and a third member 62c which forms a lower surface of the supporting member 62. In other words, in the sixth embodiment, the supporting member 62 does not include a member which forms an outer peripheral surface of the supporting member 62. The first member 62a is provided with a cooling channel 63 formed concentrically with the rotor 2, centering around the rotational axis z. A cooling medium (unillustrated) flows through the cooling channel 63.

The armature coil 5 is supported by the supporting member 62 by being fixed in contact with the first member 62a, the second member 62b, and the third member 62c. Incidentally, since a configuration of the supporting member 62 for supporting the stator cores 4 is the same as that of the first embodiment, description of the configuration will be omitted.

According to the motor of the sixth embodiment, in the event of heat generation caused by a copper loss of the armature coil 5, the heat is removed by a path from which the heat is drained by the cooling medium in the cooling channel 63 by heat conduction through a portion of the supporting member 62, and a path from which the heat is drained by heat dissipation from the outer peripheral surface of the armature coil 5.

Incidentally, the supporting member 62 is constructed of a non-magnetic and thermally conductive material, and the cooling medium is not limited to an electrical insulating fluid or gas such as insulating oil, and water or other cooling media may be widely used. According to a configuration of the base unit 60, the supporting member 62 is not limited to an electrically insulating material, and other materials which satisfy the above-described conditions may be widely used, so that a high degree of design freedom can be achieved.

### Seventh Embodiment

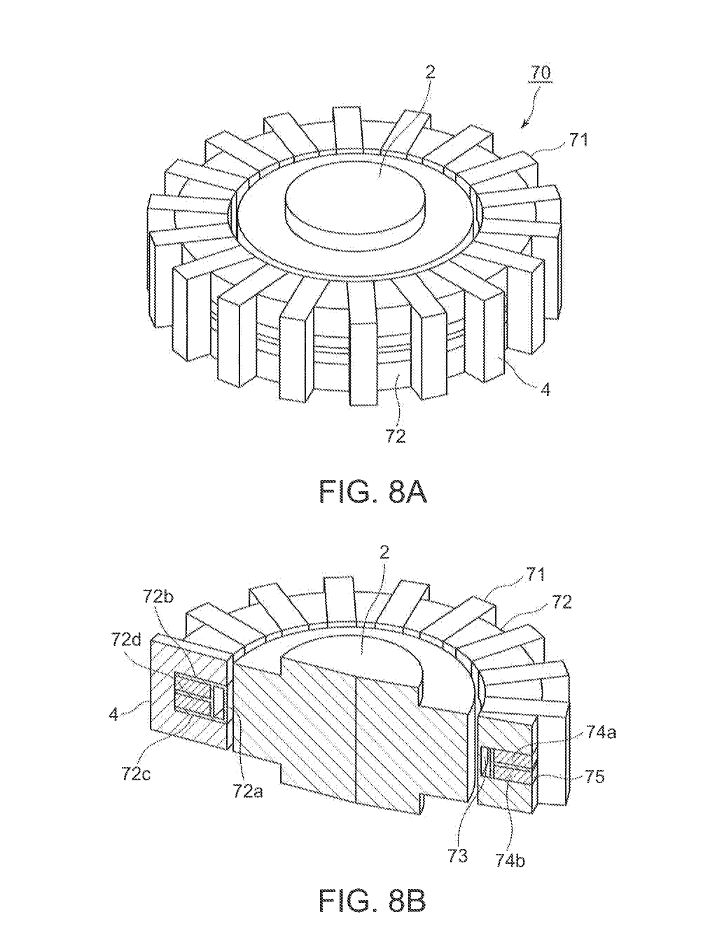

FIGS. 8A-8B illustrate a base unit 70 of a motor according to a seventh embodiment. FIG. 8A is a perspective view illustrating the base unit 70, and FIG. 8B is a vertical longitudinal sectional view of the base unit 70.

The base unit 70 includes the rotor 2 and an armature 71. Further, the armature 71 includes the eighteen stator cores 4, armature coils 74a, 74b, and a supporting member 72 containing the armature coils 74a, 74b and supporting the eighteen stator cores 4 disposed at equally spaced intervals around the rotational axis. The base unit 70 is different in including the armature coils 74a, 74b separated in the direction of the rotational axis z, as compared to the base unit 60 of FIG. 7A.

The supporting member 72 is integrally formed with a first member 72a which forms an inner peripheral surface of the supporting member 72, a second member 72b which forms an upper surface of the supporting member 72, and a third member 72c which forms a lower surface of the supporting member 72. Also, the supporting member 72 includes a fourth member 72d formed integrally with the first member 72a and provided between the armature coils 74a, 74b thereby to separate the armature coils 74a, 74b. In other words, in the seventh embodiment, the supporting member 72 does not include a member which forms an outer peripheral surface of the supporting member 72. The first member 72a is provided with a cooling channel 73 formed concentrically with the rotor 2, centering around the rotational axis z. A cooling medium (unillustrated) flows through the cooling channel 73.

The armature coils 74a, 74b are supported by the supporting member 72 by being fixed in contact with the first member 72a, the second member 72b, the third member 72c, and the fourth member 72d. Incidentally, since a configuration of the supporting member 72 for supporting the stator cores 4 is the same as that of the first embodiment, description of the configuration will be omitted.

In such an armature coil, there is a local increase in temperature in substantially a central portion of the coil, and therefore, it is necessary to determine the type of insulation coating of coil wiring according to the maximum temperature. Generally, a process for insulation coating of high heat resistance is high in cost, and therefore, it is desired that the local increase in temperature be minimized.

According to the motor of the seventh embodiment, therefore, the armature coils 74a, 74b are divided into two portions along the rotational axis with the fourth member 72d of the supporting member 72 in between, and thus, it may be expected that the effect of suppressing the local increase in temperature in the coil central portion can be achieved. Consequently, this enables contributing to size reduction of the cooling structure and cost reduction of the insulation coating process for the coil wiring.

Incidentally, the supporting member 72 is constructed of a non-magnetic and thermally conductive material, and the cooling medium is not limited to an electrical insulating fluid or gas such as insulating oil, and water or other cooling media may be widely used. According to a configuration of the base unit 70, the supporting member 72 is not limited to an electrically insulating material, and other materials which satisfy the above-described conditions may be widely used, so that a high degree of design freedom can be achieved.

### Eighth Embodiment

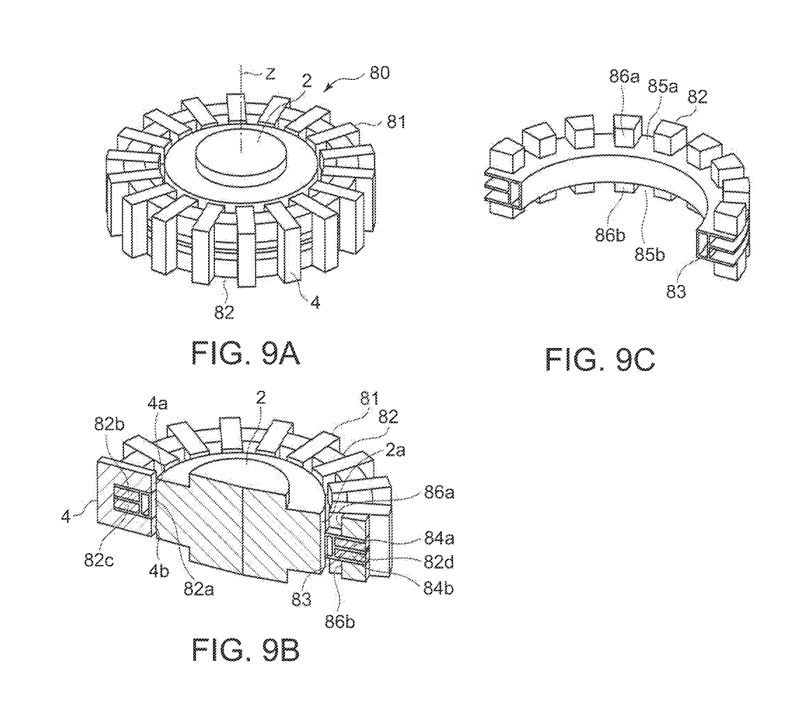

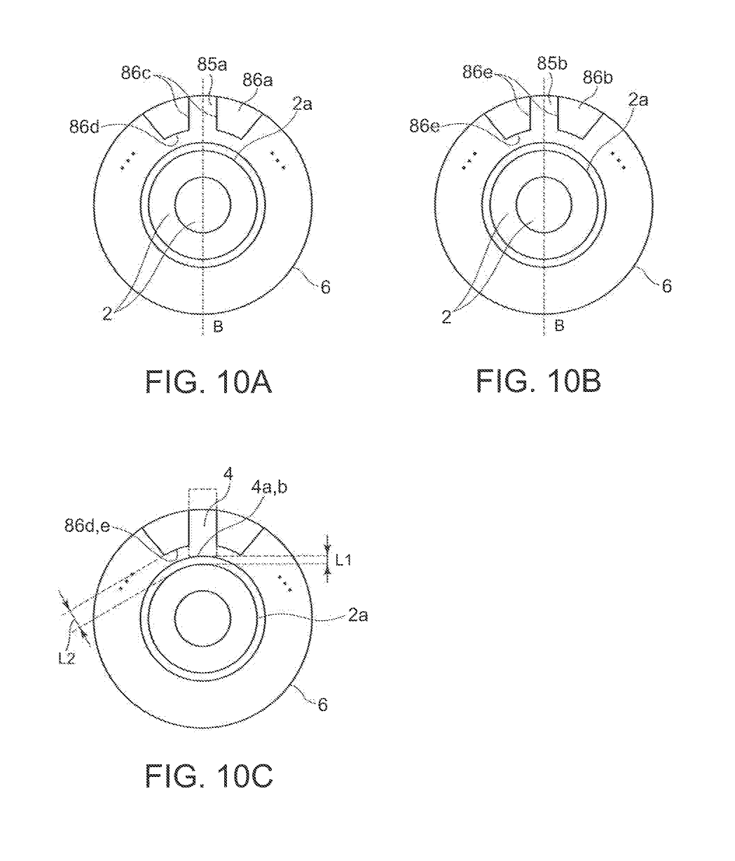

FIGS. 9A-9C and 10A-10C illustrate a base unit 80 of a motor according to an eighth embodiment. FIG. 9A is a perspective view illustrating the base unit 80; FIG. 9B is a vertical longitudinal sectional view of the base unit 80; and FIG. 9C is a vertical longitudinal sectional view of a supporting member 82 of the base unit 80. Also, FIG. 10A is a top view of the supporting member 82; FIG. 10B is a bottom view of the supporting member 82; and FIG. 10C is a view of assistance in explaining the supporting member 82. Incidentally, although the base unit 80 of FIG. 9A is based on the base unit 70 of FIG. 8A, the base unit 80 may be based on the base units of other embodiments.

The base unit 80 includes the rotor 2 and an armature 81. Further, the armature 81 includes the eighteen stator cores 4, armature coils 84a, 84b, and the supporting member 82 containing the armature coils 84a, 84b and supporting the eighteen stator cores 4 disposed at equally spaced intervals around the rotational axis z.

The supporting member 82 is integrally formed with a first member 82a which forms an inner peripheral surface of the supporting member 82, a second member 82b which forms an upper surface of the supporting member 82, and a third member 82c which forms a lower surface of the supporting member 82. Also, the supporting member 82 includes a fourth member 82d formed integrally with the first member 82a and provided between the armature coils 84a, 84b thereby to separate the armature coils 84a, 84b. The first member 82a is provided with a cooling channel 83 formed concentrically with the rotor 2, centering around the rotational axis z. A cooling medium (unillustrated) flows through the cooling channel 83.

An upper surface of the second member 82b is provided with multiple protruding portions 86a formed along the circumferential direction of the annular shape. Each of the protruding portions 86a has, as a side surface, a mounting surface 86c parallel to a reference plane B extending along the radial direction of the annular shape, and has, as an inner peripheral surface, a facing surface 86d facing the rotor outer peripheral surface 2a of the rotor 2. Also, a lower surface of the third member 82c is provided with protruding portions 86b formed along the circumferential direction of the annular shape and in phase with the protruding portions 86a. Each of the protruding portions 86b has, as a side surface, a mounting surface 86e parallel to the reference plane B extending along the radial direction of the annular shape, and has, as an inner peripheral surface, a facing surface 86e facing the rotor 2. In this case, as illustrated in FIG. 10A, the following relationship is established: L2>L1, where L1 denotes a distance between the first and second magnetic pole portions 4a, 4b of the stator core 4 and the rotor outer peripheral surface 2a of the rotor 2, and L2 denotes a distance between the facing surfaces 86d, 86e of the protruding portions 86a, 86b and the rotor outer peripheral surface 2a of the rotor 2.

Each stator core 4 is provided in such a way as to engage with a recessed portion 85a formed between the mounting surfaces 86c of the adjacent protruding portions 86a, and a recessed portion 85b formed between the mounting surfaces 86e of the adjacent protruding portions 86b. In other words, each stator core 4 is supported as a whole by the supporting member 82 by bringing the first magnetic pole portion 4a into fixed contact with the mounting surface 86c, and bringing the second magnetic pole portion 4b into fixed contact with the mounting surface 86e. Also, the armature coils 84a, 84b are supported by the supporting member 82 by being fixed in contact with the first member 82a, the second member 82b, the third member 82c, and the fourth member 82d.

According to the motor of the eighth embodiment, the protruding portions 86a, 86b which form part of the supporting member 82 are disposed facing the rotor outer peripheral surface 2a across a larger air gap, as compared to an air gap length of the first magnetic pole portion 4a and the second magnetic pole portion 4b of the stator core 4 disposed facing the rotor outer peripheral surface 2a of the rotor 2, and thus, eddy current losses which occur incident to rotation of the rotor 2 in the protruding portions 86a, 86b of the supporting member 82 can be reduced. The supporting member 82 is made of a non-magnetic and thermally conductive material and is desirably constructed of an electrically insulating material such for example as ceramics. In the base unit 80, the eddy current losses which occur in the protruding portions 86a, 86b can be reduced as described above, which in turn permits using an electrically conductive material and hence enables ensuring a high degree of design freedom. Consequently, this facilitates fabrication of the supporting member 82 and hence enables ensuring high fabrication accuracy and contributing to cost reduction.

### Ninth Embodiment

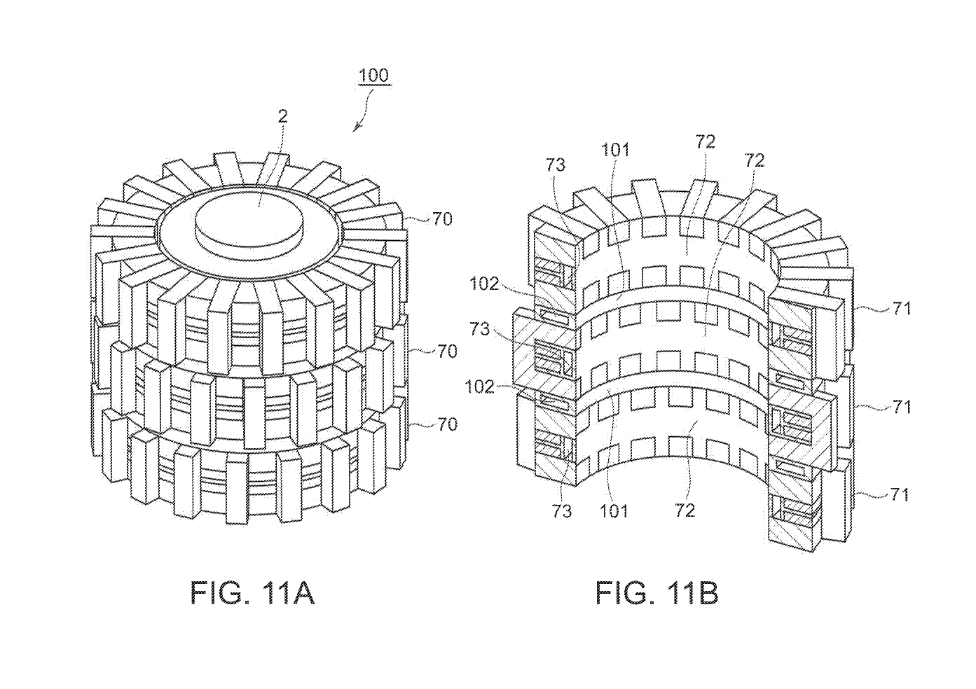

Next, description will be given with reference to FIGS. 11A-11B with regard to a motor 100 according to a ninth embodiment. FIG. 11A is a perspective view illustrating the motor 100, and FIG. 11B is a vertical longitudinal sectional view of an armature portion of the motor 100.

The motor 100 has a configuration in which the base units 70 are stacked one on top of another in three layers with linking members 101 in between along the rotational axis. Three layers of the armatures 71 are fixedly linked together in a relative phase of 120 electrical degrees with respect to a magnetic pole pitch of the stator cores between the adjacent base units 70. Meanwhile, three layers of the rotors 2 are fixedly linked together at a relative angle of 0 degree (or in phase with each other in the direction of rotation). Also, each linking member 101 is provided with an annular cooling channel 102 formed concentrically with the rotor 2, centering around the rotational axis, and are fixedly bonded to the supporting members 72. Thereby, in the event of heat generation caused by various losses, the heat is drained by the cooling medium in the cooling channels 102 by heat conduction through bonding surfaces in conjunction with the cooling channels 73 of the base units 70, and thus, many cooling paths are formed to achieve effective heat removal.

In the motor 100 having a three-layer configuration as described above, the second-level base unit 70 generally has insufficient heat drain performance as compared to the first-level and third-level base units 70, and the second-level base unit 70 tends to increase in temperature as compared to the other base units 70.

According to the motor 100 of the ninth embodiment, the two cooling channels 102 are disposed adjacent to the second-level base unit 70 at upper and lower positions, respectively, as seen in the drawing, and thus, the insufficiency of the heat drain performance of the second-level base unit 70 is eliminated, so that a temperature increase in the overall motor can be suppressed. Also, heat drain by the cooling channels 102 of the linking members 101 takes place simultaneously, which thus enables size reduction of the cooling channels 73 of the base units 70. This enables achieving size reduction of the stator cores 4 and the armature coils 74a, 74b and hence contributing to size reduction of the overall motor structure.

### Tenth Embodiment

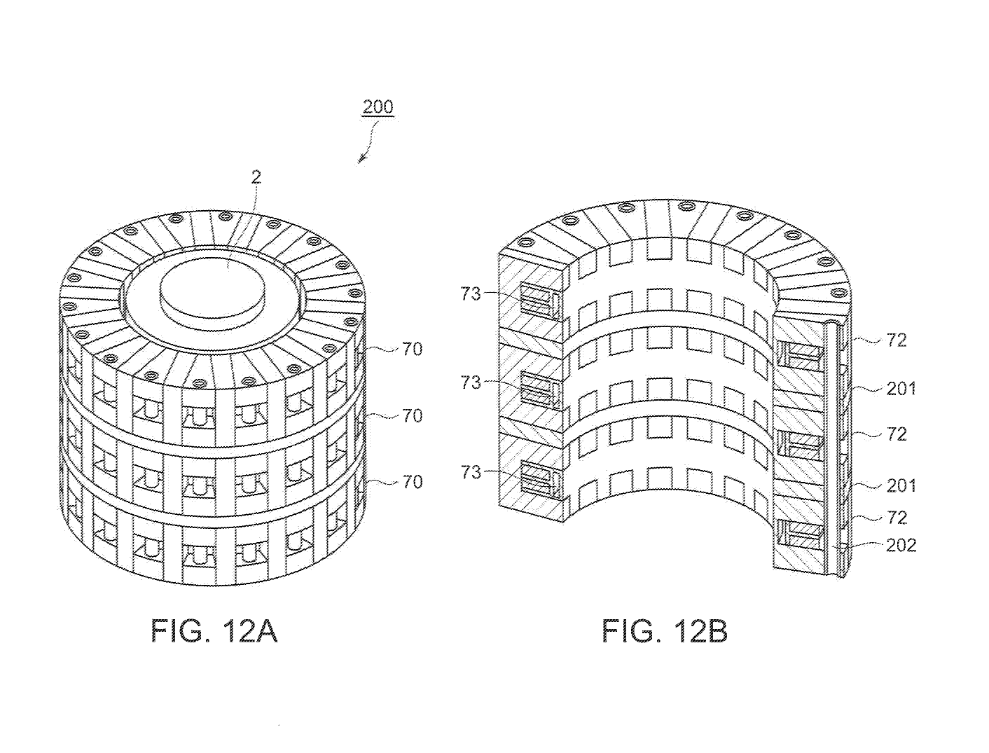

FIGS. 12A-12B illustrate a motor 200 according to a tenth embodiment. FIG. 12A is a perspective view illustrating the motor 200, and FIG. 12B is a vertical longitudinal sectional view of an armature portion of the motor 200.

The motor 200 has a configuration in which the base units 70 are stacked one on top of another in three layers with linking members 201 in between along the rotational axis. Three layers of the armatures 71 are fixedly linked together at a relative angle of 0 degree (or in phase with each other in the direction of rotation) between the adjacent base units 70. Meanwhile, three layers of the rotors 2 are fixedly linked together in a relative phase (unillustrated) of 120 electrical degrees with respect to the magnetic pole pitch of the stator cores. Here, the linking members 201 are configured to have a predetermined mechanical strength required for the motor and have low heat resistance, and are fixedly bonded to the base units 70 along the rotational axis. Further, the motor 200 is provided with eighteen cooling pipes 202 extending through the supporting members 72 of the base units 70 and the linking members 201 around the rotational axis, and the cooling pipes 202 are fixedly bonded to the supporting members 72 and the linking members 201. Then, a typical method (unillustrated) is used to allow the flowing of a cooling medium through the cooling pipes 202 and thereby form a cooling mechanism. Thereby, in the event of heat generation caused by various losses, the heat is drained by the cooling medium in the cooling pipes 202 by heat conduction in conjunction with the cooling channels 73 of the base units 70, and thus, many cooling paths are formed to achieve effective heat removal.

According to the motor 200 of the tenth embodiment, the installation of the multiple cooling pipes 202 is feasible with relative ease, and thus, many cooling paths are formed to achieve high-performance heat removal. Also, heat drain by the cooling pipes 202 of the linking members 201 takes place simultaneously, which thus enables size reduction of the cooling channels 73 of the base units 70. This enables achieving size reduction of the stator cores 4 and the armature coils 74a, 74b and hence contributing to size reduction of the overall motor structure.

### Eleventh Embodiment

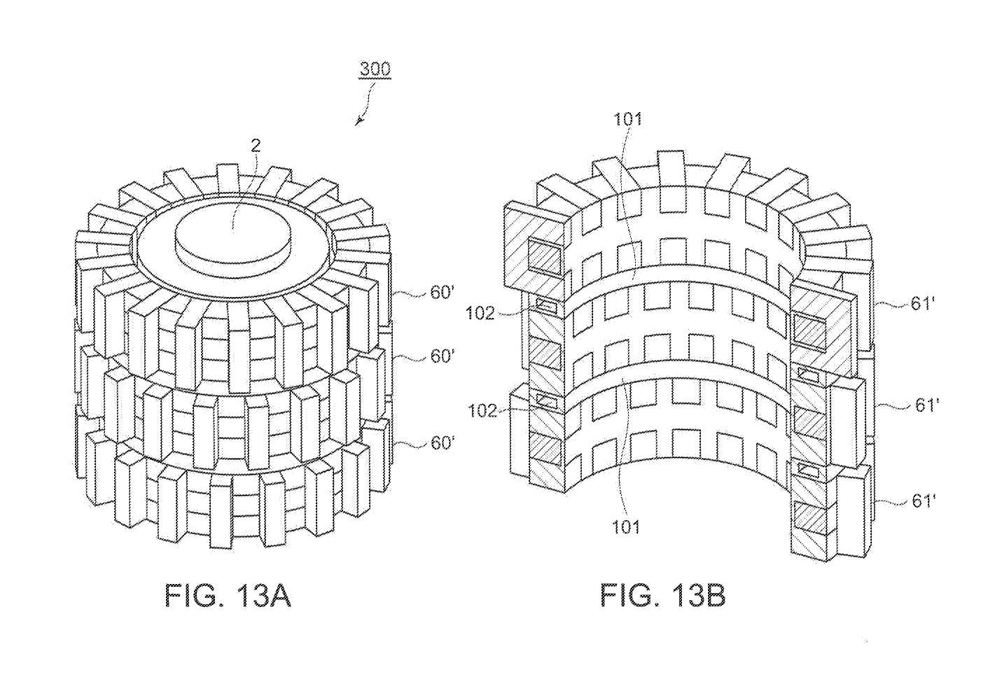

FIGS. 13A-13B illustrate a motor 300 according to an eleventh embodiment. FIG. 13A is a perspective view illustrating the motor 300, and FIG. 13B is a vertical longitudinal sectional view of an armature portion of the motor 300.

Although the motor 300 is similar in configuration to the motor 100, the motor 300 is different in being configured by using base units 60′ in place of the base units 70. The base unit 60′ includes the rotor 2, and an armature 61′ obtained by removing the cooling channel 63 from the base unit 60.

According to the motor 300 of the eleventh embodiment, the base unit 60′ does not include the cooling channel, and thus, it may be expected that the base unit can be significantly reduced in size, particularly in the dimension in the radial direction. Also, it is not necessary to provide a cooling flow path (unillustrated) to be linked to the cooling channel 63, which in turn can contribute to a significant simplification of a base unit structure and hence provide the motor which achieves cost reduction as well as size reduction and simplification.

### Twelfth Embodiment

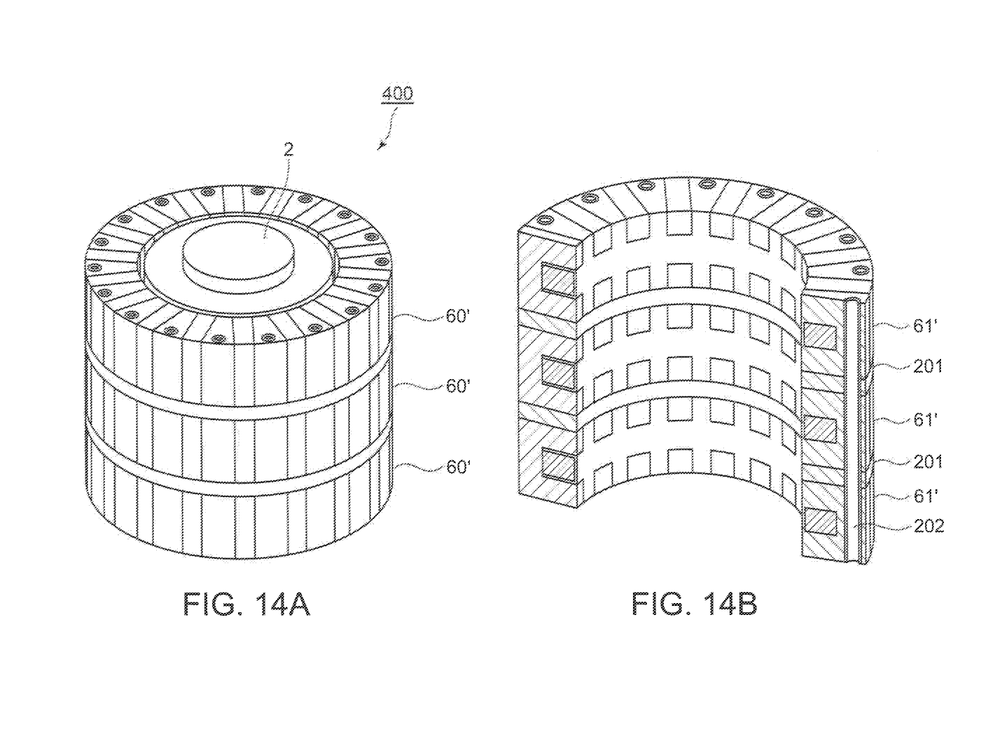

FIGS. 14A-14B illustrate a motor 400 according to a twelfth embodiment. FIG. 14A is a perspective view illustrating the motor 400, and FIG. 14B is a vertical longitudinal sectional view of an armature portion of the motor 400.

Although the motor 400 is similar in configuration to the motor 200, the motor 400 is different in being configured by using the base units 60′ in place of the base units 70.

According to the motor 400 of the twelfth embodiment, the base unit 60′ does not include the cooling channel, and thus, it may be expected that the base unit can be significantly reduced in size, particularly in the dimension in the radial direction. Also, it is not necessary to provide a cooling flow path (unillustrated) to be linked to the cooling channel 63, which in turn can contribute to a significant simplification of the base unit structure and hence provide the motor which achieves cost reduction as well as size reduction and simplification. Further, the installation of the multiple cooling pipes 202 is feasible with relative ease, and thus, many cooling paths are formed to achieve high-performance heat removal. As a result, the motor having a high level of cooling performance, as well as having the small-sized and simplified structure, can be provided.

According to the motor according to at least one of the embodiments described above, noise generation can be suppressed.

These embodiments are for purposes of illustration only and are not intended to limit the scope of the invention. These embodiments may be carried out in other various forms, and various omissions, replacements and changes may be made in the invention without departing from the spirit and scope of the invention. These embodiments and modifications thereof are included in the scope and basic concept of the invention and are included in the scope of the invention as defined in the appended claims and equivalents thereof.

What is claimed is:

1. A transverse flux motor comprising:
a rotor having an outer peripheral surface;
an annular armature coil wound around a rotational axis of the rotor;
a stator core including a pair of magnetic pole portions along an axial direction of the rotational axis, each magnetic pole portion facing the outer peripheral surface of the rotor across a gap; and
a supporting member containing the armature coil, and having a plurality of protruding portions protruding in the axial direction and provided around the rotational axis, wherein the adjacent two protruding portions around the rotational axis support at least part of the magnetic pole portions between the adjacent two protruding portions.

2. The transverse flux motor according to claim 1, wherein
the stator core has a first side surface in each of the magnetic pole portions,
each protruding portion has a second side surface parallel to a reference plane extending through the rotational axis and along the rotational axis, and
the first side surface and the second side surface are in contact with each other.

3. The transverse flux motor according to claim 2, wherein
the supporting member includes a first member including an upper surface of the supporting member, and a second member including a lower surface of the supporting member, the first member and the second member being provided along the axial direction of the rotational axis, and
each protruding portion includes a first protruding portion provided on an upper surface of the first member, and a second protruding portion provided on a lower surface of the second member.

4. The transverse flux motor according to claim 3, wherein
the supporting member further includes a third member including an inner peripheral surface of the supporting member and facing the rotor, and
the armature coil is surrounded by at least the first member, the second member, and the third member.

5. The transverse flux motor according to claim 4, wherein
the armature coil is divided into a plurality of portions along the rotational axis, and
the supporting member further includes a fourth member formed integrally with the third member, the fourth member being provided between the portions.

6. The transverse flux motor according to claim 1, wherein the supporting member includes a cooling channel in at least a portion of the supporting member.

7. The transverse flux motor according to claim 1, wherein the supporting member is made of a non-magnetic and thermally conductive material.

8. The transverse flux motor according to claim 1, wherein a distance between the protruding portions and the rotor is greater than a distance between the magnetic pole portions and the rotor.

9. The transverse flux motor according to claim 1, wherein the supporting member is made of an electrically insulating material.

10. The transverse flux motor according to claim 8, wherein the supporting member is made of an electrically conductive material.

11. A transverse flux motor comprising:
a plurality of armatures including a rotor having an outer peripheral surface,
an annular armature coil wound around a rotational axis of the rotor, a stator core including a pair of magnetic pole portions along an axial direction of the rotational axis, each magnetic pole portion facing the outer peripheral surface of the rotor across a gap and a supporting member containing the armature coil, and having a plurality of protruding portions protruding in the axial direction and provided around the rotational axis, wherein the adjacent two protruding portions around the rotational axis support at least part of the magnetic pole portions between the adjacent two protruding portions,
a linking member which links the armatures along the rotational axis.

12. A transverse flux motor according to claim 11,
wherein the armatures are linked together in a relative phase of approximate 120 electrical degrees with respect to a magnetic pole pitch of the stator cores between the adjacent armature.

13. A transverse flux motor according to claim 11,
wherein the rotors are linked together at a relative angle of approximate 0 degree.

14. A transverse flux motor according to claim 11 further comprising:
an annular cooling channel formed in the linking member.

15. A transverse flux motor according to claim 11 further comprising:
a cooling pipe extending through the supporting members and the linking member.

16. A transverse flux motor according to claim 11,
wherein a cooling member is provided in the linking member without providing the cooling member in the armature.

17. A transverse flux motor according to claim 11,
wherein the supporting member includes a cooling channel.
